(19) United States
(12) Patent Application Publication
(10) Pub. No.: US 2024/0292336 A1
(43) Pub. Date: Aug. 29, 2024

(54) POWER-SAVING IN MULTI-ANTENNA WIRELESS DEVICES

(71) Applicant: QUALCOMM Incorporated, San Diego, CA (US)

(72) Inventors: Yi Liu, Shenzhen (CN); Jiugang Gao, Shenzhen (CN); Yuankun Zhu, Shanghai (CN); Fojian Zhang, Shenzhen (CN); Zhenqing Cui, Shanghai (CN); Haojun Wang, Xian, Shaanxi (CN); Jinglin Zhang, Senzhen (CN); Zhanzhong Yuan, Shenzhen (CN); Yuanqiang Cai, Shenzhen (CN)

(21) Appl. No.: 18/573,218

(22) PCT Filed: Sep. 2, 2021
(86) PCT No.: PCT/CN2021/116113

§ 371 Date: Dec. 21, 2023

(51) Int. Cl. H04W 52/02; H04B 7/0404

(52) U.S. Cl. CPC H04W 52/0277; H04B 7/0404

(57) ABSTRACT

Wireless communication between a mobile device or user equipment (UE) having a plurality of antennas and a base station includes signaling a reduced capability with respect to a number of antennas used for an uplink transmission. To reduce UE power consumption, e.g., when a battery is low and/or when a throughput is low, a UE may signal a lower capability, such as one that uses fewer antennas than the UE has available for an uplink transmission. The UE may then deactivate RF circuitry coupled to one or more antennas to reduce power consumption without significantly reducing performance.

### INTRODUCTION

In wireless communications, it can be useful for a wireless device to communicate using multiple antennas. For example, a multiple-antenna device can provide an improved signal-to-noise ratio or improved performance when communicating over disparate frequency ranges. MIMO (multiple-input multiple-output) technology is one example where multiple antenna elements enhance system performance in multipath reception environments. Another example is the use of multiple transmission/reception point (MTRP) technologies, in which a user device may communicate with multiple base stations or other transmission-reception points (TRPs). MTRP and other technologies may use directional transmission and reception techniques like beamforming for improved performance. These and other technologies may involve user equipment and other devices using two or more directional antennas and/or a phased array of antennas.

As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In various aspects this disclosure proves for wireless communication procedures by which user equipment (a UE) capable of using multiple antennas may signal to a base-station (BS) that it is capable of using fewer antennas than it is actually capable of using, allowing the UE to reduce power consumption by deactivating circuitry coupled to those antennas.

Some aspects of the disclosure provide a wireless communication device operable as user equipment (a UE) comprising a processor, a transceiver communicatively coupled to the processor, a plurality of antennas coupled to the transceiver, the antennas configured to enable a single-antenna configuration, and to enable a multi-antenna configuration, and a memory coupled to the processor. Here, the processor and the memory are configured to cause the UE to transmit, via the transceiver, a first capability information message indicating that the UE is configured to use a first number of antennas of the plurality of antennas for uplink transmissions. Based on a change of at least one of a power state of the UE or a throughput of the UE, the processor and the memory are further configured to transmit, via the transceiver, a second capability information message indicating that the UE is configured to use a second number of antennas, different from the first number of antennas, for uplink transmissions.

In further aspects, the disclosure provides a method of wireless communication operable at user equipment (a UE) having a plurality of antennas. Here, the method comprises transmitting a first capability information message indicating that the UE is configured to use a first number of antennas of the plurality of antennas for uplink transmissions, and, based on a change of at least one of a power state of the UE or a throughput of the UE, transmitting a second capability information message indicating that the UE is configured to use a second number of antennas, different from the first number of antennas, for uplink transmissions.

In still further aspects, the disclosure provides a wireless communication device operable as user equipment (a UE) comprising a plurality of antennas configured to enable a single-antenna configuration for wireless communication, and to enable a multi-antenna configuration for wireless communication. The wireless communication device further comprises means for transmitting a first capability information message indicating that the UE is configured to use a first number of antennas of the plurality of antennas for uplink transmissions, and means for transmitting, based on a change of at least one of a power state of the UE or a throughput of the UE, a second capability information message indicating that the UE is configured to use a second number of antennas, different from the first number of antennas, for uplink transmissions.

And in still further aspects, the disclosure provides a non-transitory computer readable medium storing computer executable code comprising instructions for a wireless communication device operable as user equipment (a UE) comprising a plurality of antennas configured to enable a single-antenna configuration, and to enable a multi-antenna configuration. Here, the computer executable code comprises instructions for causing the UE to transmit a first capability information message indicating that the UE is configured to use a first number of antennas of the plurality of antennas for uplink transmissions, and, based on a change of at least one of a power state of the UE or a throughput of the UE, to transmit a second capability information message indicating that the UE is configured to use a second number of antennas, different from the first number of antennas, for uplink transmissions.

These and other aspects of the technology discussed herein will become more fully understood upon a review of the detailed description, which follows. Other aspects, features, and embodiments will become apparent to those of ordinary skill in the art, upon reviewing the following description of specific, exemplary embodiments in conjunction with the accompanying figures. While the following description may discuss various advantages and features relative to certain embodiments and figures, all embodiments can include one or more of the advantageous features discussed herein. In other words, while this description may discuss one or more embodiments as having certain advantageous features, one or more of such features may also be used in accordance with the various embodiments discussed herein. In similar fashion, while this description may discuss exemplary embodiments as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects of this disclosure.

FIG. 2 is a conceptual illustration of an example of a radio access network according to some aspects of this disclosure.

FIG. 3 is a block diagram illustrating a wireless communication system supporting multiple-input multiple-output (MIMO) communication according to some aspects of this disclosure.

FIG. 4 is a block diagram conceptually illustrating an example of a hardware implementation for a scheduling entity according to some aspects of this disclosure.

FIG. 5 is a block diagram conceptually illustrating an example of a hardware implementation for a scheduled entity according to some aspects of this disclosure.

FIG. 6 is a flow chart illustrating an exemplary process for a mobile device to signal its capabilities relating to the use of multiple antennas according to some aspects of this disclosure.

FIG. 7 is a flow chart illustrating an exemplary process for a mobile device to transmit a capability information message based on a change in a power state and/or a throughput according to some aspects of this disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and embodiments by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

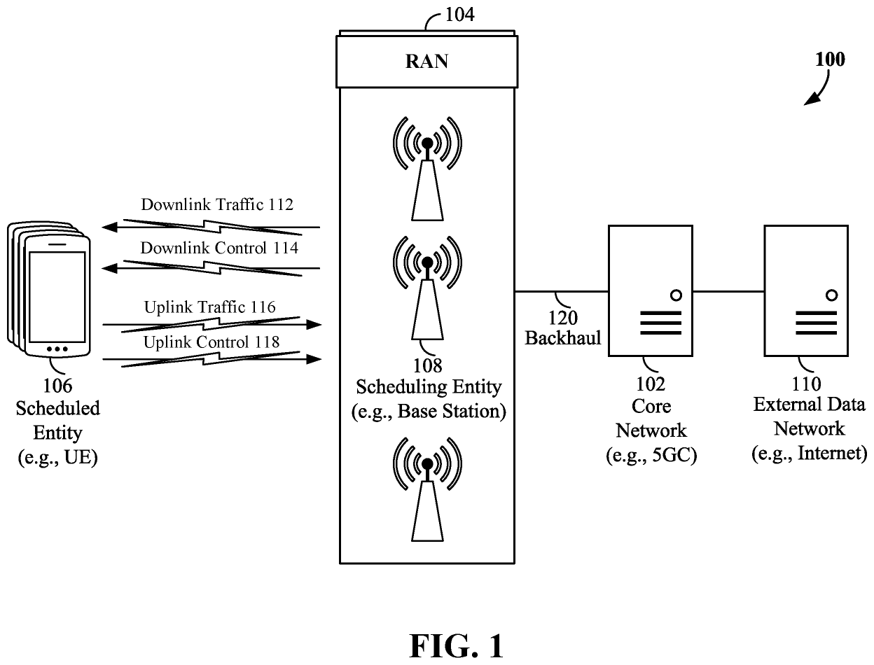

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains: a core network 102, a radio access network (RAN) 104, and a user equipment (UE) 106. By virtue of the wireless communication system 100, the UE 106 may carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, those skilled in the art may variously refer to a base station as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 supports wireless communication for multiple mobile apparatuses. Those skilled in the art may refer to a mobile apparatus as user equipment (UE) in 3GPP standards, but may also be refer to a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device: a logistics controller: agricultural equipment: military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

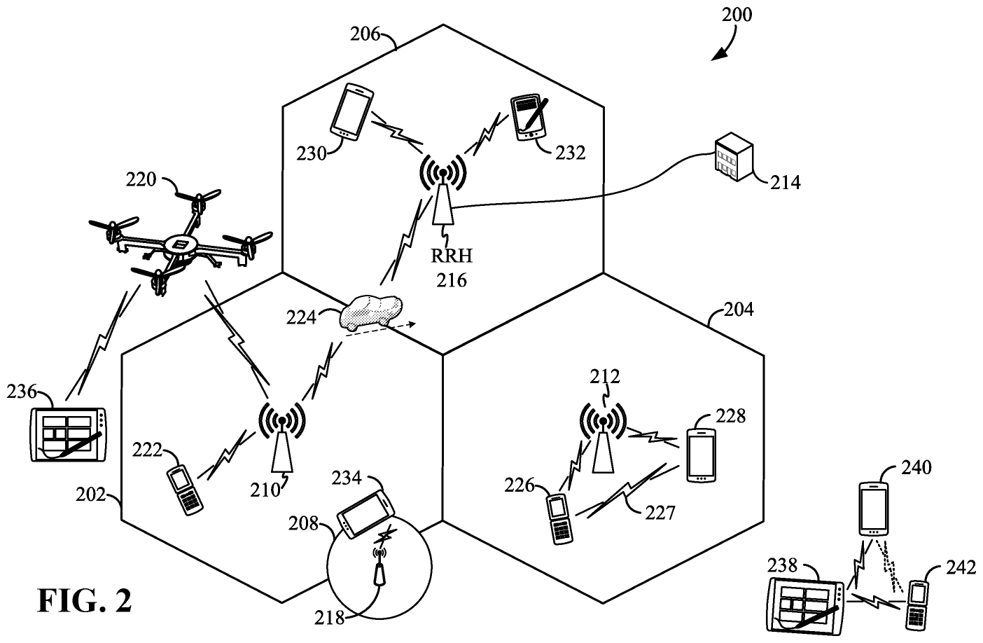

FIG. 2 provides a schematic illustration of a RAN 200, by way of example and without limitation. In some examples, the RAN 200 may be the same as the RAN 104 described above and illustrated in FIG. 1. The geographic area covered by the RAN 200 may be divided into cellular regions (cells) that a user equipment (UE) can uniquely identify based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell. In some examples, a base station may include any suitable of one or more antenna panels.

FIG. 2 shows two base stations 210 and 212 in cells 202 and 204; and shows a third base station 214 controlling a remote radio head (RRH) 216 in cell 206. That is, a base station can have an integrated antenna or can be connected to an antenna or RRH by feeder cables. In the illustrated example, the cells 202, 204, and 126 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

The RAN 200 may include any number of wireless base stations and cells. Further, a RAN may include a relay node to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a mobile base station (e.g., a quadcopter 220 or other drone which may be configured to function as a base station). That is, in some examples, a cell may not necessarily be stationary, and the geographic area of the cell may move according to the location of the quadcopter 220 (e.g., the quadcopter or drone pictured).

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with the quadcopter 220 acting as a mobile base station. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the UE 238 operating as a scheduling entity. Thus, in a wireless communication system with scheduled access to time-frequency resources and having a cellular configuration, a P2P configuration, or a mesh configuration, a scheduling entity and one or more scheduled entities may communicate utilizing the scheduled resources.

In the RAN 200, the ability for a UE to communicate while moving, independent of its location, is referred to as mobility. An access and mobility management function (AMF, not illustrated, part of the core network 102 in FIG. 1) may generally set up, maintain, and release the various physical channels between the UE and the radio access network. The AMF may further include a security context management function (SCMF) that manages the security context for both the control plane and the user plane functionality, and a security anchor function (SEAF) that performs authentication.

The air interface in the RAN 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time utilizing a given resource. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

In order for transmissions over the radio access network 200 to obtain a low block error rate (BLER) while still achieving very high data rates, a transmitter may use channel coding. That is, wireless communication may generally utilize a suitable error correcting block code. In a typical block code, a transmitter splits up an information message or sequence into code blocks (CBs), and an encoder (e.g., a CODEC) at the transmitting device then mathematically adds redundancy to the information message. Exploitation of this redundancy in the encoded information message can improve the reliability of the message, enabling correction for bit errors that may occur due to the noise.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes. For example, a UE may provide for UL multiple access utilizing time division multiple access (TDMA), code division multiple access (CDMA), frequency division multiple access (FDMA), sparse code multiple access (SCMA), resource spread multiple access (RSMA), or other suitable multiple access schemes. Further, a base station may multiplex DL transmissions to UEs utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

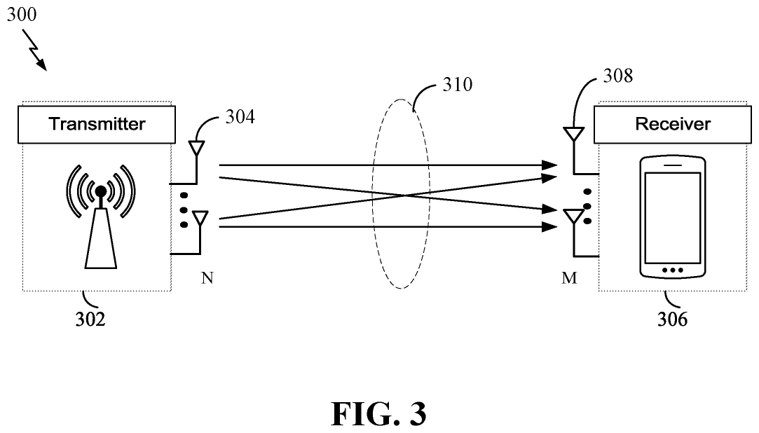

In some aspects of the disclosure, the scheduling entity and/or scheduled entity may be configured with multiple antennas for beamforming and/or multiple-input multiple-output (MIMO) technology. FIG. 3 illustrates an example of a wireless communication system 300 with multiple-antenna devices, supporting beamforming and/or MIMO. The use of such multiple antenna technology enables the wireless communication system to exploit the spatial domain to support spatial multiplexing, beamforming, and transmit diversity. Directional antennas (i.e., antennas having anisotropic radiation patterns with directional gain) used for 5G communication are frequently electrically-steerable planar antennas such as planar arrays of antenna elements operated as phased arrays. Thus, individual antennas may be referred to antenna panels. The distinction between one antenna panel and another may be physical or virtual: that is, a device may have multiple physically separate antennas or a device may dynamically select subsets of antenna elements from a pool of antenna elements to operate as multiple virtual antenna panels enabling simultaneous communication over multiple spatial channels.

Beamforming generally refers to directional signal transmission or reception. For a beamformed transmission, a transmitting device may precode, or control the amplitude and/or phase of each antenna element in an array to create a desired (e.g., directional) pattern of constructive and destructive interference in the wavefront (i.e., a “beam”). In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

In some aspects of this disclosure, a UE configured for uplink (UL) MIMO, UL beamforming, or any other suitable multi-antenna uplink transmission may be configurable to activate and/or deactivate circuits and/or components coupled to one or more of its antennas. In this way, a UE may reduce its power consumption during uplink transmissions, e.g., when its remaining battery is low, or when a multi-antenna uplink transmission may not be needed (e.g., when a throughput is low).

In various examples, a wireless transmission may carry one or more physical channels, including control channels, shared channels, data channels, etc. A wireless transmission may also carry pilots or reference signals. These pilots or reference signals may provide for a receiving device to perform channel estimation of the corresponding channel, which may enable coherent demodulation/detection of the control and/or data channels.

In a downlink (DL) transmission, the transmitting device (e.g., the base station 108) may allocate wireless resources to carry one or more DL control channels. These DL control channels include DL control information 114 (DCI) that generally carries information originating from higher layers, such as a physical broadcast channel (PBCH), a physical downlink control channel (PDCCH), etc., to one or more scheduled entities 106. In addition, the base station 108 may allocate DL resources to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

The PDCCH may carry downlink control information (DCI) for one or more UEs in a cell. This can include, but is not limited to, power control commands, a redundancy version (RV), scheduling information (e.g., as a time-domain resource allocation (TDRA) that indicates time-slots allocated to a particular communication and/or a frequency-domain resource allocation (FDRA) that indicates frequency ranges allocated for the communication), a grant, an assignment of REs for DL and UL transmissions, an SRS resource indicator (SRI) indicating time-frequency resources to be used for SRS transmission, a dedicated multi-antenna selection indicator, and/or any other suitable control information.

In an uplink (UL) transmission, a transmitting device (e.g., a UE 106) may utilize scheduled resources to carry one or more UL control channels, such as a physical uplink control channel (PUCCH), a physical random access channel (PRACH), etc. These UL control channels include UL control information 118 (UCI) that generally carries information originating from higher layers. Further, UL resources may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the base station 108 to schedule uplink transmissions. Here, in response to the SR transmitted on the control channel 118, the base station 108 may transmit downlink control information 114 that may schedule resources for UL packet transmissions.

In some examples, a wireless communication network (such as one configured for 5G NR) may be configured for interoperation with many types and categories of devices, which can have a wide range of capabilities that differ from one another. For example, different devices may utilize a wider or a narrower bandwidth, different signal waveforms, etc. In a further example, some devices may include multiple antennas, which can potentially confer to those devices a capability for MIMO and/or beamforming, as discussed above. On the other hand, other devices may include only a single antenna. To enable support for such a range of devices, a network may employ UE capability information signaling so that a given UE can inform the network relevant information about its own capabilities. According to some examples, a UE may provide such capability information at appropriate or suitable times, such as upon initial network acquisition, during mobility between cells, etc. In a particular example, when a given UE is in a dormant or low-power state where signaling with a network is reduced or eliminated for some time, the UE may provide such capability information periodically or on an event-driven basis so that the currently local cell(s) can be configured for communication with that UE. For example, in 3GPP specifications for 5G NR, in this scenario a UE may transmit a tracking area update (TAU) message to the network. In response, the network may send the UE a capability inquiry message to establish that UE's capabilities. Accordingly, the UE may transmit suitable UE capability information to the network. Some examples of a UE capability information message may include parameters such as the maximum number of MIMO layers the UE is capable of providing for an UL transmission. Other examples may include parameters such as a number of UE antennas available for UL transmission. Those of ordinary skill in the art will recognize that any suitable parameters may be included in such capability information messages.

In addition to control information, a base station may allocate resources for user data or traffic data. Such traffic may be carried on one or more traffic channels, such as, for a DL transmission, a physical downlink shared channel (PDSCH); or for an UL transmission, a physical uplink shared channel (PUSCH).

The channels or carriers described above are not necessarily all the channels or carriers that may be utilized between a base station 108 and UEs 106, and those of ordinary skill in the art will recognize that other channels or carriers may be utilized in addition to those illustrated, such as other traffic, control, and feedback channels. It will be further appreciated that, although examples herein may describe multi-antenna communications utilizing two antennas, that such examples are not intended to limit embodiments herein to utilizing only one or two antennas. Embodiments may utilize any suitable number of antennas according to different applications.

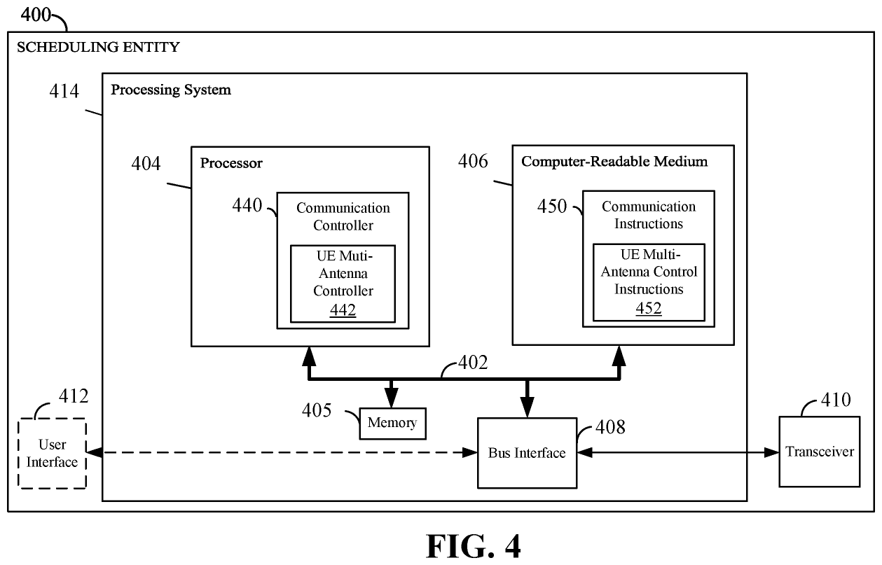

FIG. 4 is a block diagram illustrating an example of a hardware implementation for a scheduling entity 400 employing a processing system 414. For example, the scheduling entity 400 may be a user equipment (UE) as illustrated in any one or more of FIGS. 1, 2, and/or 3. In another example, the scheduling entity 400 may be a base station as illustrated in any one or more of FIGS. 1, 2, and/or 3.

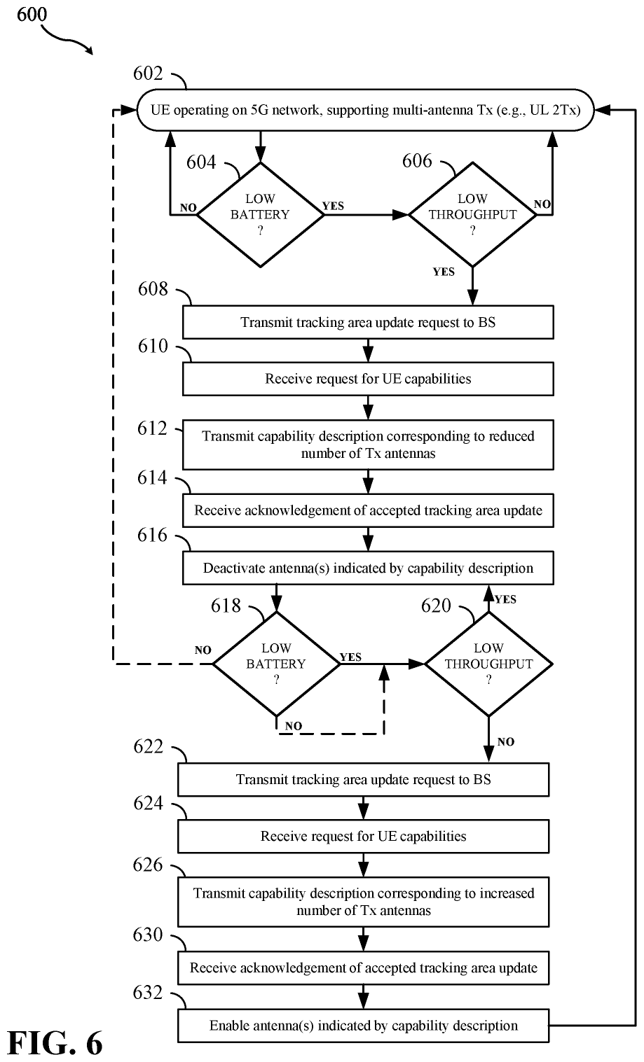

The scheduling entity 400 may include a processing system 414 having one or more processors 404. Examples of processors 404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 400 may be configured to perform any one or more of the functions described herein. That is, the processor 404, as utilized in a scheduling entity 400, may be configured (e.g., in coordination with the memory 405) to implement or enable any one or more of the processes and procedures performed by a scheduled entity described below and illustrated, e.g., in FIG. 6.

The processing system 414 may be implemented with a bus architecture, represented generally by the bus 402. The bus 402 may include any number of interconnecting buses and bridges depending on the specific application of the processing system 414 and the overall design constraints. The bus 402 communicatively couples together various circuits including one or more processors (represented generally by the processor 404), a memory 405, and computer-readable media (represented generally by the computer-readable medium 406). The bus 402 may also link various other circuits such as timing sources, peripherals, voltage regulators, and power management circuits, which are well known in the art, and therefore, will not be described any further. A bus interface 408 provides an interface between the bus 402 and a transceiver 410. The transceiver 410 provides a communication interface or means for communicating with various other apparatus over a transmission medium. Depending upon the nature of the apparatus, a user interface 412 (e.g., keypad, display, speaker, microphone, joystick) may also be provided. Of course, such a user interface 412 is optional, and some examples, such as a base station, may omit it.

In some aspects of the disclosure, the processor 404 may include a communication controller 440 and a UE multi-antenna controller 442 (e.g., in coordination with the memory 405) for various functions, including, e.g., receiving and processing UE capability signaling, which may include a UE's multi-antenna capability, and communicating with those devices accordingly. For example, the UE multi-antenna controller 442 may be configured respond to tracking area update requests from UEs, retrieve UE capability information, allocate uplink resources that are appropriate for the capabilities of UEs, and schedule PUCCH and PUSCH transmissions over the allocated resources.

The processor 404 is responsible for managing the bus 402 and general processing, including the execution of software stored on the computer-readable medium 406. The software, when executed by the processor 404, causes the processing system 414 to perform the various functions described below for any particular apparatus. The processor 404 may also use the computer-readable medium 406 and the memory 405 for storing data that the processor 404 manipulates when executing software.

One or more processors 404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 406. The computer-readable medium 406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 406 may reside in the processing system 414, external to the processing system 414, or distributed across multiple entities including the processing system 414. The computer-readable medium 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable medium 406 may store computer-executable code that includes communication instructions 450 (which include UE multi-antenna control instructions 452) that configure a scheduling entity 400 for various functions, including, e.g., requesting information concerning UE capabilities and scheduling transmissions over physical resources that are allocated according to those capabilities. For example, the UE multi-antenna control instructions 452 may be configured to cause a scheduling entity 400 to determine that a UE supports multi-antenna transmission and may schedule PUCCH and PUSCH communications for those antennas.

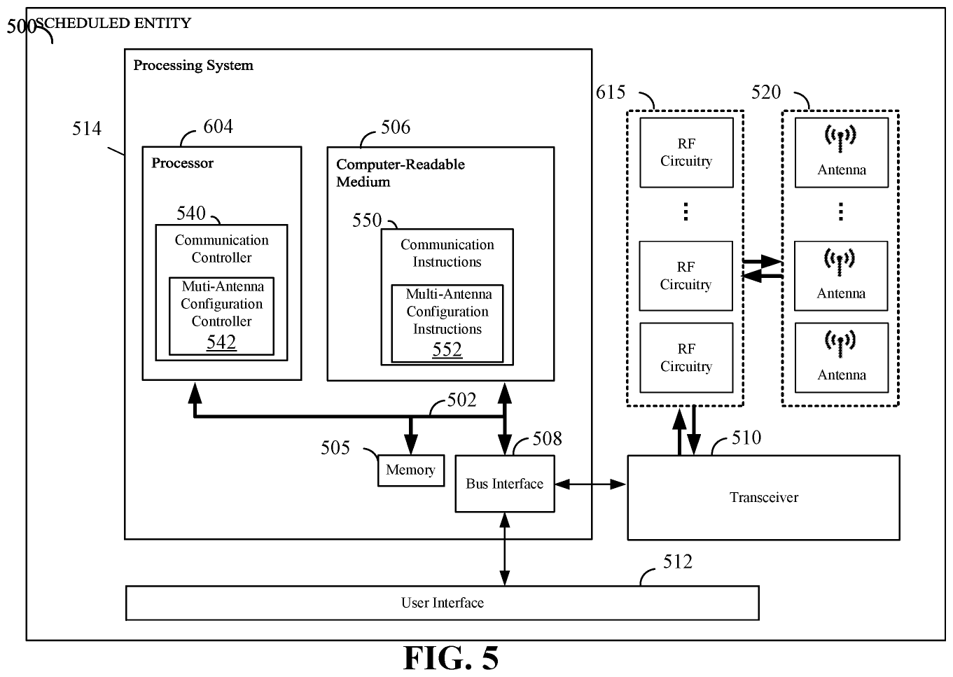

FIG. 5 is a conceptual diagram illustrating an example of a hardware implementation for an exemplary scheduled entity 500 employing a processing system 514. In accordance with various aspects of the disclosure, a processing system 514 may include an element, or any portion of an element, or any combination of elements having one or more processors 504. For example, the scheduled entity 500 may be a user equipment (UE) as illustrated in any one or more of FIGS. 1, 2, and/or 3.

The processing system 514 may be substantially the same as the processing system 414 illustrated in FIG. 4, including a bus interface 508, a bus 502, memory 505, a processor 504, and a computer-readable medium 506. Furthermore, the scheduled entity 500 may include a user interface 512 and a transceiver 510 substantially similar to those described above in FIG. 4. That is, the processor 504, as utilized in a scheduled entity 500, may be configured (e.g., in coordination with the memory 505) to implement any one or more of the processes described below and illustrated, e.g., in FIG. 6.

The transceiver 510 is coupled to two or more antennas 520 that are usable for transmission and/or reception of wireless signals. As shown, the transceiver 510 may be coupled to one or more antennas (e.g., the antennas 520) via RF circuitry 515. In some examples each antenna 520 may be uniquely associated with and coupled to particular RF circuitry 515. For instance, each antenna 520 may be coupled to a dedicated set of RF amplifiers, active and/or passive filter elements, and so on. Although not shown for simplicity, each transmitter may be coupled to a respective power amplifier (PA) which amplifies the signal to be transmitted. The combination of a transmitter and a PA may be referred to herein as a “transmit chain” or “TX chain.” To save on cost or die area, the same PA may be reused to transmit signals over multiple TX antennas. In other words, one or more TX chains of a UE may each be selectively coupled to one or more TX antenna ports. In some examples, the RF circuitry 515 may form a portion of the transceiver 510.

Each antenna 520 may be an individual antenna, and/or may be either physically or electrically steerable (e.g., an electrically steerable phased array). In some examples, one or more antennas 520 may be “virtual antennas” formed by dynamically addressing individual receiver elements in a reconfigurable array and operating those receiver elements as a phased array having characteristics desired for a particular application or desired at a particular point in time.

In some aspects of the disclosure, the processor 504 may include a communication controller 540 including a multi-antenna configuration controller 542 configured (e.g., in coordination with the memory 505) for various functions, including, for example, activating and deactivating circuitry coupled to various antennas in response to one or more power states and/or current data throughput, and signaling multi-antenna and/or single-antenna capabilities of the UE in corresponding configuration states. For instance, the communication controller 540 may be configured to implement one or more of the functions described below in relation to FIG. 6 including, e.g., blocks 602-626.

And further, the computer-readable storage medium 506 may store computer-executable code that includes communication instructions 550 that include multi-antenna configuration instructions 552 that configure a scheduled entity 500 for various functions, including, for activating and deactivating circuitry coupled to various antennas in response to one or more power states and/or current data throughput, and signaling multi-antenna and single-antenna capabilities of the UE in corresponding configuration states. For instance, the communication instructions 550 may be configured to cause a scheduled entity 500 to implement one or more of the functions described below in relation to FIG. 6, including, e.g., blocks 602-632.

Of course, in the above examples, the circuitry included in the processor 504 is merely provided as an example, and other means for carrying out the described functions may be included within various aspects of the present disclosure, including but not limited to the instructions stored in the computer-readable storage medium 506, or any other suitable apparatus or means described in any one of the FIGS. 1, 2, and/or 3, and utilizing, for example, the processes and/or algorithms described herein in relation to FIG. 6.

FIG. 6 is a flow chart illustrating an exemplary process 600 for a UE (or other scheduled entity) to signal multi-antenna configuration information in accordance with some aspects of the present disclosure. As described below, a particular implementation may omit some or all illustrated features and may not require some illustrated features to implement all embodiments. In some examples, the scheduled entity 500 illustrated in FIG. 5 may be configured to carry out the process 600. In some examples, any suitable apparatus or means for carrying out the functions or algorithm described below may carry out the process 600.

At block 602 the process 600 may begin with the UE operating on a 5G or other suitable network that supports multi-antenna transmission by the UE. As one example, the UE may be connected to a 5G network and in a configuration supporting dual-antenna uplink transmissions (“UL 2Tx”).

In the exemplary process described below, blocks 604 and 606 are described in a sequential manner. However, in another example, the sequence of blocks 604 and 606 may be reversed. And in further examples, rather than sequentially making the determinations in blocks 604 and 606, a UE may carry out any suitable logical operation of the respective determinations, such as to proceed to block 608 if either a low battery state exists, or if a low throughput state exists.

At block 604, the UE obtains information indicating a current power state of the UE (e.g., a battery state such as percent capacity remaining, a battery terminal voltage, or any other suitable indication of remaining energy available to the UE, such as remaining charge expressed in milliamp-hours, or mAh, or other units). In various examples, a power state of the UE may change if a battery voltage falls below or rises above a voltage threshold, if a remaining battery energy falls below or rises above an energy threshold, etc. And in some examples, a battery state may be considered to change when a user connects or disconnects a charger, or otherwise initiates or halts a charging of a UE battery. If the UE is not in a low available power (“low power”) state, the UE may return to block 602 and continue to operate in a default (or previous) multi-antenna configuration. If the UE is in a low power state, the UE may proceed to block 606.

At block 606, the UE obtains throughput information (e.g., by accessing stored logs or other information indicating the data transfer history of the UE) over one or more suitable time intervals. In some examples, a time interval (or intervals) may be preconfigured, received from the network, or received from a user of the device, or received in any other suitable manner. The UE may determine that it is in a low-throughput state if a time-averaged amount of data transferred during the time interval is less than a predetermined amount (e.g., less than 1 Mbps). In some examples, a UE may be configured to perform the actions of blocks 604 and 606 periodically (e.g., once per minute), or in an event-driven fashion. For example, a UE may be configured to generate an interrupt signal when the UE enters a low power state or a low-throughput state. If the UE is in both a low power state and low throughput state, the UE may continue to block 608.

At block 608, the UE transmits a suitable message to the BS to initiate a UE capability information exchange with the network. For example, a UE may transmit a tracking area update (TAU) request message. A TAU message is known to those skilled in the art, and is commonly used for mobility management, enabling a network to locate a given UE that may have been in a low-power mode and relocated without signaling the network. Here, a TAU message may cause the BS to respond by transmitting a request for capability information of the UE that indicates supported communication configurations of the UE (e.g., whether the UE supports multi-antenna reception and/or transmission, and/or a number of supported antennas for reception and/or transmission).

At block 610 the UE receives (e.g., utilizing its wireless transceiver 510) a request for its capability information. For example, the UE may receive a UE capability inquiry message from the BS, requesting the UE to provide the network with a suitable response indicating one or more relevant capabilities, features, or functions of the UE.

At block 612 the UE transmits capability information that corresponds to a suitable number (e.g., a reduced number) of Tx antennas. For example, the UE may signal that it only supports a single-antenna transmission configuration (“UL 1Tx”) rather than a dual-antenna transmission configuration (“UL 2Tx”). Signaling a reduced number of available antennas may enable the UE to deactivate transceiver circuitry (e.g., RF circuitry 515) coupled to one or more antennae (e.g., the antennas 520), allowing the UE to reduce power consumption.

At block 614 the UE may receive an acknowledgement message from the BS indicating that the tracking area update requested at block 608 has been accepted. Those skilled in the art will recognize this as including an example with a tracking area update accept message according to 5G NR specifications.

At block 616, the UE may deactivate an antenna or antennas that are not needed to provide the capabilities signaled to the network at block 612. For example, the UE may stop supplying electrical power to one or more transmission-side amplifiers and/or other active components (e.g., active filtering circuitry) used to transmit signals using the antenna(s) that are not needed. In some examples, the UE may deactivate one or more virtual antennas. In still further examples, a UE may reduce its maximum supported number of carriers in carrier aggregation. That is, a UE may reduce power consumption by reducing its maximum supported number of layers and/or its maximum supported number of carriers, and signal such reduction in UE capability to the network.

When the UE is placed into a reduced transmission capability state (e.g., UL 1Tx), the UE may periodically determine whether to remain in that state or to resume a higher-capability transmission state (e.g., a multi-antenna transmission function such as UL 2Tx) by reactivating one or more deactivated antennas by proceeding to block 618.

At block 618 (similarly to block 604 above), the UE may determine whether it is (still) in a low power state. In some examples, if the UE is no longer in the low power state the UE may optionally return to a higher-power state by returning to block 602. In other examples, the UE may proceed to block 620. If the UE is still in the low-power state the UE may proceed to block 620.

At block 620, the UE determines (similarly to block 606) whether it is also still in the low-throughput state. If the UE is still in the low throughput state, the UE may return to block 616 and keep any previously deactivated antenna(s) in their deactivated state(s). If the UE is no longer in the low throughput state, the UE may proceed to block 622. In some examples, the UE may determine it is no longer in the low bandwidth state (or should no longer be in the low bandwidth state by accessing instantaneous throughput (as described above in connection with block 606. In other examples, the UE may access logged information and determine that the throughput for transmitted data is increasing or increasing at a rate of increase that is larger than a threshold. In yet other examples, the UE may determine that an amount of data queued for transmission exceeds a threshold or that a priority of data queued for transmission is higher than a threshold. In still further examples, the UE may determine that higher throughput is needed when a predetermined, specified application or program is opened or executed.

If the UE is no longer in a low-power state and/or no longer in the low-throughput state (or it is undesirable for the UE to remain in that state), the UE may proceed to blocks 622-630 (analogously with blocks 608-614) in order to provide the network with updated capabilities.

At block 622, the UE uses the transceiver 510 to transmit a tracking area update request to the BS. The tracking area update request is configured to cause the BS to transmit a request for capability information of the UE that indicates supported communication configurations of the UE (e.g., whether the UE supports multi-antenna reception and/or transmission, and a number of supported antennas for reception and/or transmission).

At block 624 the UE receives a request for its capabilities (e.g., a UE capability inquiry) from the BS.

At block 626 the UE may use the transceiver 510 to transmit capability information that corresponds to an increased number of Tx antennae relative to the low throughput state. For example, the UE may signal that it now supports a double-antenna transmission configuration (“UL 2Tx”) rather than a previous single-antenna configuration (“UL 1Tx”). Signaling an increased number of available antennas may enable the UE to re-activate transceiver circuitry coupled to one or more antennas with relative certainty that the BS (and/or other devices in communication with the UE) is appropriately configured to receive transmissions from the activating antennas of the UE.

At block 630 the UE may receive an acknowledgement via the transceiver 510 that the tracking request update requested at block 622 has been accepted.

At block 632, the UE may activate or reactivate an antenna or antennas that were not used to provide the capabilities signaled to the network at block 612 and are used to provide the increased capabilities signaled at block 626. For example, the UE may begin or resume supplying electrical power to one or more transmission-side amplifiers or other active components (e.g., active filtering circuitry) used to transmit signals using the antenna(s) that were previously not needed. The UE may then return to block 602 and operate in an increased throughput configuration (e.g., UL 2Tx). In some examples, the UE may recover a maximum supported number of MIMO layers, a maximum number of component carriers for carrier aggregation, or any other suitable such recovery of capabilities.

It will be understood that, examples above are not intended to limit aspects of the disclosure to only single-panel and dual-panel configurations (or single or dual antennas). For instance, a UE might support configurations using any number of antennas and/or antenna panels and may be configured to transition between any suitable number of configurations according to one or more power state conditions and/or one or more throughput state conditions. For instance, in one example, a UE might support single-panel, dual-panel, and triple-panel configurations and transition between these states as described or above or one or more similar fashions.

As mentioned above, a UE may perform processes such as the process 600 to reduce power consumption. In an example, a suitable transceiver and RF circuitry (e.g., the transceiver 510 coupled to, or incorporating, the RF circuitry 515) may be configured to support both UL 1Tx and UL 2Tx at power levels in the approximate range of 0 dBm to 23 dBm, for each antenna or antenna panel. RF circuitry (and/or corresponding portions of a transceiver) coupled to each antenna or antenna panel may be associated with current consumption on the order of 100 mA at 0 dBm and current consumption on the order of 200 mA at 23 dBm. At power supply voltages of 2-3 V, each “active” antenna may be associated with a minimum power draw of ˜200 mW even at relatively low transmit power levels. Therefore, temporarily deactivating one antenna (e.g., by switching from a configuration supporting UL 2Tx to one supporting UL 1Tx only) may result in power savings of ˜200 mW or more. If a UE's uplink bandwidth needs can be adequately met during a given time period, then the UE may save power without appreciably affecting performance of the UE.

Thus it will be appreciated that aspects of the disclosure have the advantage of power savings for power-limited UEs without unduly limiting performance and user experience. This is due to the fact that in certain aspects, a power-limited UE will only reduce its transmit capabilities when a lower capability level is adequate to satisfy real-time (or near-real-time) throughput requirements as measured by the UE itself.

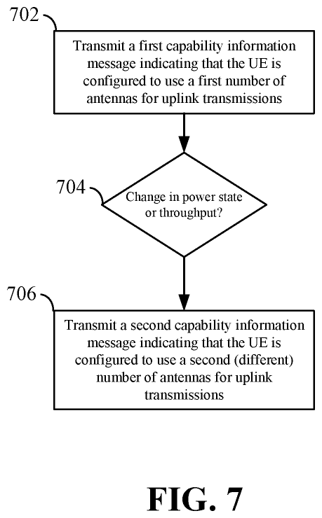

FIG. 7 is a flow chart illustrating a further exemplary process 700 for a UE (or other scheduled entity) to signal multi-antenna configuration information in accordance with some aspects of the present disclosure. As described below, a particular implementation may omit some or all illustrated features and may not require some illustrated features to implement all embodiments. In some examples, the scheduled entity 500 illustrated in FIG. 5 may be configured to carry out the process 700. In some examples, any suitable apparatus or means for carrying out the functions or algorithm described below may carry out the process 700.

At block 702, a UE may transmit a first capability information message. Here, this first message may indicate that the UE is configured to use a first number of antennas for uplink transmissions. For example, a UE capability information message may indicate a maximum number of UL MIMO layers that the UE supports, from which the number of antennas for UL transmission may be inferred.

At block 704, the UE may determine whether there is a change in a UE power state and/or a UE throughput. For example, if a UE determines that it has a low battery, or that a battery voltage has fallen below a voltage threshold, this may correspond to a change in its power state. In another example, if a UE determines that its battery has received energy such that it no longer has a low battery, or that the battery voltage has risen above a voltage threshold, or that a battery charger has been connected to charge the UE battery, this may also correspond to a change in its power state. On the other hand, if a UE determines that its throughput has fallen below (or risen above) a throughput threshold, this may correspond to a change in throughput. Here, the change in UE power state and/or throughput may be determined with reference to the UE power state and/or throughput at or near the time when the UE transmitted the first capability information message in block 702.

At block 706, based on a change in a UE power state and/or throughput, the UE may transmit a second capability information message. For example, this second message may indicate that the UE is configured to use a second number of antennas (different from the first number) for uplink transmissions. In various examples, the capability information messages may not directly correspond to the true capabilities of the UE. That is, as described above, to reduce power consumption, a UE may disable multi-antenna transmissions (or employ a smaller number of antennas).

### Further Examples Having a Variety of Features:

Example 1: A wireless communication device operable as user equipment (a UE) comprising a processor, a transceiver communicatively coupled to the processor, a plurality of antennas coupled to the transceiver, the antennas configured to enable a single-antenna configuration, and to enable a multi-antenna configuration, and a memory coupled to the processor. Here, the processor and the memory are configured to cause the UE to transmit, via the transceiver, a first capability information message indicating that the UE is configured to use a first number of antennas of the plurality of antennas for uplink transmissions. Based on a change of at least one of a power state of the UE or a throughput of the UE, the processor and the memory are further configured to transmit, via the transceiver, a second capability information message indicating that the UE is configured to use a second number of antennas, different from the first number of antennas, for uplink transmissions.

Example 2: The wireless communication device of example 1, wherein the change of the power state of the UE corresponds to a battery voltage falling below a voltage threshold, or a remaining battery energy falling below an energy threshold.

Example 3: The wireless communication device of any of examples 1-2, wherein the processor and the memory are further configured to cause the UE to receive at least one of the energy threshold or the voltage threshold via a user interface of the UE.

Example 4: The wireless communication device of any of examples 1-3, wherein the change of the throughput of the UE corresponds to the throughput falling below a throughput threshold.

Example 5: The wireless communication device of any of examples 1-4, wherein, based on the second capability information message, the processor and the memory are further configured to cause the UE to deactivate radio-frequency (RF) circuitry coupled to at least one antenna of the plurality of antennas, and to transmit, via the transceiver, an uplink transmission using the second number of antennas.

Example 6: The wireless communication device of any of examples 1-5, wherein, based on a further change of at least one of the power state of the UE or the throughput of the UE, the processor and the memory are further configured to cause the UE to transmit a third capability information message indicating that the UE is configured to use the first number of antennas, to reactivate the RF circuitry coupled to the at least one antenna, and to transmit, via the transceiver, a further uplink transmission using the first number of antennas.

Example 7: The wireless communication device of any of examples 1-6, wherein, based on the change of at least one of the power state of the UE or the throughput of the UE, the processor and the memory are further configured to cause the UE to transmit a first tracking area update request message, and to transmit the second capability information message in response to a UE capability inquiry message.

Example 8: A method of wireless communication operable at user equipment (a UE) having a plurality of antennas. Here, the method comprises transmitting a first capability information message indicating that the UE is configured to use a first number of antennas of the plurality of antennas for uplink transmissions, and, based on a change of at least one of a power state of the UE or a throughput of the UE, transmitting a second capability information message indicating that the UE is configured to use a second number of antennas, different from the first number of antennas, for uplink transmissions.

Example 9: The method of example 8, wherein the change of the power state of the UE corresponds to a battery voltage falling below a voltage threshold, or a remaining battery energy falling below an energy threshold.

Example 10: The method of any of examples 8-9, further comprising receiving at least one of the energy threshold or the voltage threshold via a user interface of the UE.

Example 11: The method of any of examples 8-10, wherein the change of the throughput of the UE corresponds to the throughput falling below a throughput threshold.

Example 12: The method of any of examples 8-11, further comprising, based on the second capability information message: deactivating radio-frequency (RF) circuitry coupled to at least one antenna of the plurality of antennas, and transmitting an uplink transmission using the second number of antennas.

Example 13: The method of any of examples 8-12, further comprising, based on a further change of at least one of the power state of the UE or the throughput of the UE: transmitting a third capability information message indicating that the UE is configured to use the first number of antennas, reactivating the RF circuitry coupled to the at least one antenna, and transmitting a further uplink transmission using the first number of antennas.

Example 14: The method of any of examples 8-13, further comprising, based on the change of at least one of the power state of the UE or the throughput of the UE: transmitting a first tracking area update request message, and transmitting the second capability information message in response to a UE capability inquiry message.

Example 15: A wireless communication device operable as user equipment (a UE) comprising a plurality of antennas configured to enable a single-antenna configuration for wireless communication, and to enable a multi-antenna configuration for wireless communication. The wireless communication device further comprises means for transmitting a first capability information message indicating that the UE is configured to use a first number of antennas of the plurality of antennas for uplink transmissions, and means for transmitting, based on a change of at least one of a power state of the UE or a throughput of the UE, a second capability information message indicating that the UE is configured to use a second number of antennas, different from the first number of antennas, for uplink transmissions.

Example 16: The wireless communication device of example 15, wherein the change of the power state of the UE corresponds to a battery voltage falling below a voltage threshold, or a remaining battery energy falling below an energy threshold.

Example 17: The wireless communication device of any of examples 15-16, further comprising a means for user input, configured for receiving at least one of the energy threshold or the voltage threshold.

Example 18: The wireless communication device of any of examples 15-17, wherein the change of the throughput of the UE corresponds to the throughput falling below a throughput threshold.

Example 19: The wireless communication device of any of examples 15-18, further comprising means for, based on the second capability information message: deactivating radio-frequency (RF) circuitry coupled to at least one antenna of the plurality of antennas, and transmitting an uplink transmission using the second number of antennas.

Example 20: The wireless communication device of any of examples 15-19, further comprising means for, based on a further change of at least one of the power state of the UE or the throughput of the UE: transmitting a third capability information message indicating that the UE is configured to use the first number of antennas, reactivating the RF circuitry coupled to the at least one antenna, and transmitting a further uplink transmission using the first number of antennas.

Example 21: The wireless communication device of any of examples 15-20, further comprising means for, based on the change of at least one of the power state of the UE or the throughput of the UE: transmitting a first tracking area update request message, and transmitting the second capability information message in response to a UE capability inquiry message.

Example 22: A non-transitory computer readable medium storing computer executable code comprising instructions for a wireless communication device operable as user equipment (a UE) comprising a plurality of antennas configured to enable a single-antenna configuration, and to enable a multi-antenna configuration. Here, the computer executable code comprises instructions for causing the UE to transmit a first capability information message indicating that the UE is configured to use a first number of antennas of the plurality of antennas for uplink transmissions, and, based on a change of at least one of a power state of the UE or a throughput of the UE, to transmit a second capability information message indicating that the UE is configured to use a second number of antennas, different from the first number of antennas, for uplink transmissions.

Example 23: The non-transitory computer readable medium of example 22, wherein the change of the power state of the UE corresponds to a battery voltage falling below a voltage threshold, or a remaining battery energy falling below an energy threshold.

Example 24: The non-transitory computer readable medium of any of examples 22-23, wherein the computer executable code further comprises instructions for causing the UE to receive at least one of the energy threshold or the voltage threshold via a user interface of the UE.

Example 25: The non-transitory computer readable medium of any of examples 22-24, wherein the change of the throughput of the UE corresponds to the throughput falling below a throughput threshold.

Example 26: The non-transitory computer readable medium of any of examples 22-25, wherein the computer executable code further comprises instructions for causing the UE to, based on the second capability information message: deactivate radio-frequency (RF) circuitry coupled to at least one antenna of the plurality of antennas, and transmit an uplink transmission using the second number of antennas.

Example 27: The non-transitory computer readable medium of any of examples 22-26, wherein the computer executable code further comprises instructions for causing the UE to, based on a further change of at least one of the power state of the UE or the throughput of the UE, transmit a third capability information message indicating that the UE is configured to use the first number of antennas, to reactivate the RF circuitry coupled to the at least one antenna, and to transmit a further uplink transmission using the first number of antennas.

Example 28: The non-transitory computer readable medium of any of examples 22-27, wherein the computer executable code further comprises instructions for causing the UE to, based on the change of at least one of the power state of the UE or the throughput of the UE, transmit a first tracking area update request message, and to transmit the second capability information message in response to a UE capability inquiry message.

This disclosure presents several aspects of a wireless communication network with reference to an exemplary implementation. As those skilled in the art will readily appreciate, various aspects described throughout this disclosure may be extended to other telecommunication systems, network architectures, and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3^{rd} Generation Partnership Project 2 (3GPP2), such as CDMA2000 and/or Evolution-Data Optimized (EV-DO). Other examples may be implemented within systems employing IEEE 602.11 (Wi-Fi), IEEE 602.16 (WiMAX), IEEE 602.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The present disclosure uses the term “coupled” to refer to a direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features, and/or functions illustrated in FIGS. 1-7 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-7 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a: b; c: a and b: a and c: b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The terms “may” and “can” as used in connection with aspects and features herein are equivalent and refer to elements which are present in certain embodiments but not necessarily others, or to describe actions that are performed by a particular device or component in one aspect that are capable of being performed by other devices or components in aspects.

What is claimed is:

1. A wireless communication device operable as user equipment (a UE) comprising:
a processor;
a transceiver communicatively coupled to the processor;
a plurality of antennas coupled to the transceiver, the antennas configured to enable a single-antenna configuration, and to enable a multi-antenna configuration; and
a memory coupled to the processor,
wherein the processor and the memory are configured to cause the UE to:
transmit, via the transceiver, a first capability information message indicating that the UE is configured to use a first number of antennas of the plurality of antennas for uplink transmissions; and
based on a change of at least one of a power state of the UE or a throughput of the UE, transmit, via the transceiver, a second capability information message indicating that the UE is configured to use a second number of antennas, different from the first number of antennas, for uplink transmissions.

2. The wireless communication device of claim 1, wherein the change of the power state of the UE corresponds to a battery voltage falling below a voltage threshold, or a remaining battery energy falling below an energy threshold.

3. The wireless communication device of claim 2, wherein the processor and the memory are further configured to cause the UE to receive at least one of the energy threshold or the voltage threshold via a user interface of the UE.

4. The wireless communication device of claim 1, wherein the change of the throughput of the UE corresponds to the throughput falling below a throughput threshold.

5. The wireless communication device of claim 1, wherein, based on the second capability information message, the processor and the memory are further configured to cause the UE to:
deactivate radio-frequency (RF) circuitry coupled to at least one antenna of the plurality of antennas; and
transmit, via the transceiver, an uplink transmission using the second number of antennas.

6. The wireless communication device of claim 5, wherein the processor and the memory are further configured to cause the UE to:
based on a further change of at least one of the power state of the UE or the throughput of the UE, transmit a third capability information message indicating that the UE is configured to use the first number of antennas;
reactivate the RF circuitry coupled to the at least one antenna; and
transmit, via the transceiver, a further uplink transmission using the first number of antennas.

7. The wireless communication device of claim 1, wherein the processor and the memory are further configured to cause the UE to:
based on the change of at least one of the power state of the UE or the throughput of the UE, transmit a first tracking area update request message; and
transmit the second capability information message in response to a UE capability inquiry message.

8. A method of wireless communication operable at user equipment (a UE) having a plurality of antennas, the method comprising:
transmitting a first capability information message indicating that the UE is configured to use a first number of antennas of the plurality of antennas for uplink transmissions; and
based on a change of at least one of a power state of the UE or a throughput of the UE, transmitting a second capability information message indicating that the UE is configured to use a second number of antennas, different from the first number of antennas, for uplink transmissions.

9. The method of claim 8, wherein the change of the power state of the UE corresponds to a battery voltage falling below a voltage threshold, or a remaining battery energy falling below an energy threshold.

10. The method of claim 9, further comprising receiving at least one of the energy threshold or the voltage threshold via a user interface of the UE.

11. The method of claim 8, wherein the change of the throughput of the UE corresponds to the throughput falling below a throughput threshold.

12. The method of claim 8, further comprising, based on the second capability information message:
deactivating radio-frequency (RF) circuitry coupled to at least one antenna of the plurality of antennas; and
transmitting an uplink transmission using the second number of antennas.

13. The method of claim 12, further comprising:
based on a further change of at least one of the power state of the UE or the throughput of the UE, transmitting a third capability information message indicating that the UE is configured to use the first number of antennas;
reactivating the RF circuitry coupled to the at least one antenna; and
transmitting a further uplink transmission using the first number of antennas.

14. The method of claim 8, further comprising:
based on the change of at least one of the power state of the UE or the throughput of the UE, transmitting a first tracking area update request message; and
transmitting the second capability information message in response to a UE capability inquiry message.

15. A wireless communication device operable as user equipment (a UE) comprising:
a plurality of antennas configured to enable a single-antenna configuration for wireless communication, and to enable a multi-antenna configuration for wireless communication;
means for transmitting a first capability information message indicating that the UE is configured to use a first number of antennas of the plurality of antennas for uplink transmissions; and
means for transmitting, based on a change of at least one of a power state of the UE or a throughput of the UE, a second capability information message indicating that the UE is configured to use a second number of antennas, different from the first number of antennas, for uplink transmissions.

16. The wireless communication device of claim 15, wherein the change of the power state of the UE corresponds to a battery voltage falling below a voltage threshold, or a remaining battery energy falling below an energy threshold.

17. The wireless communication device of claim 16, further comprising a means for user input, configured for receiving at least one of the energy threshold or the voltage threshold.

18. The wireless communication device of claim 15, wherein the change of the throughput of the UE corresponds to the throughput falling below a throughput threshold.

19. The wireless communication device of claim 15, further comprising, based on the second capability information message:
means for deactivating radio-frequency (RF) circuitry coupled to at least one antenna of the plurality of antennas; and
means for transmitting an uplink transmission using the second number of antennas.

20. The wireless communication device of claim 19, further comprising:
means for transmitting, based on a further change of at least one of the power state of the UE or the throughput of the UE, a third capability information message indicating that the UE is configured to use the first number of antennas;
means for reactivating the RF circuitry coupled to the at least one antenna; and
means for transmitting a further uplink transmission using the first number of antennas.

21. The wireless communication device of claim 15, further comprising:
means for transmitting, based on the change of at least one of the power state of the UE or the throughput of the UE, a first tracking area update request message; and
means for transmitting the second capability information message in response to a UE capability inquiry message.

22. A non-transitory computer readable medium storing computer executable code comprising instructions for a wireless communication device operable as user equipment (a UE) comprising a plurality of antennas configured to enable a single-antenna configuration, and to enable a multi-antenna configuration, the computer executable code comprising instructions for causing the UE to:
transmit a first capability information message indicating that the UE is configured to use a first number of antennas of the plurality of antennas for uplink transmissions; and
based on a change of at least one of a power state of the UE or a throughput of the UE, transmit a second capability information message indicating that the UE is configured to use a second number of antennas, different from the first number of antennas, for uplink transmissions.

23. The non-transitory computer readable medium of claim 22, wherein the change of the power state of the UE corresponds to a battery voltage falling below a voltage threshold, or a remaining battery energy falling below an energy threshold.

24. The non-transitory computer readable medium of claim 23, wherein the computer executable code further comprises instructions for causing the UE to receive at least one of the energy threshold or the voltage threshold via a user interface of the UE.

25. The non-transitory computer readable medium of claim 22, wherein the change of the throughput of the UE corresponds to the throughput falling below a throughput threshold.

26. The non-transitory computer readable medium of claim 22, wherein the computer executable code further comprises instructions for causing the UE to, based on the second capability information message:
deactivate radio-frequency (RF) circuitry coupled to at least one antenna of the plurality of antennas; and
transmit an uplink transmission using the second number of antennas.

27. The non-transitory computer readable medium of claim 26, wherein the computer executable code further comprises instructions for causing the UE to:
based on a further change of at least one of the power state of the UE or the throughput of the UE, transmit a third capability information message indicating that the UE is configured to use the first number of antennas;
reactivate the RF circuitry coupled to the at least one antenna; and
transmit a further uplink transmission using the first number of antennas.

28. The non-transitory computer readable medium of claim 22, wherein the computer executable code further comprises instructions for causing the UE to:
based on the change of at least one of the power state of the UE or the throughput of the UE, transmit a first tracking area update request message; and
transmit the second capability information message in response to a UE capability inquiry message.
